(19) United States
(12) Patent Application Publication
(10) Pub. No.: US 2018/0229356 A1
(43) Pub. Date: Aug. 16, 2018

(54) Side Handle

(71) Applicant: HILTI AKTIENGESELLSCHAFT, Schaan (LI)

(72) Inventors: Adrian STEINGRUBER, Schwabmuenchen (DE); Oliver OHLENDORF, Landsberg (DE)

(73) Assignee: HILTI AKTIENGESELLSCHAFT, Schaan (LI)

(21) Appl. No.: 15/749,735

(22) PCT Filed: Jul. 26, 2016
(86) PCT No.: PCT/EP2016/067764

§ 371 Date: Feb. 1, 2018

(30) Foreign Application Priority Data
Aug. 6, 2015 (EP) 15179926.9

(51) Int. Cl. B25F 5/02; B25F 5/00

(52) U.S. Cl. CPC B25F 5/026; B25D 17/043; B25F 5/006

(57) ABSTRACT

The side handle for a hand-operated power tool (5) has a handle rod (2) which is arranged along a handle axis (7) and intended for holding the side handle (1) by one hand, a fastening mechanism (3) and a damper (6). The fastening mechanism (3) for releasably fastening the side handle (1) to the hand-operated power tool (5) has a tensioning band (10), which engages around a fastening axis (12), and a tensioning mechanism (11). The tensioning mechanism (11) has a collar (16) which overlaps with the tensioning band (10) along the handle axis (7) and is displaceable with respect to the tensioning band (10) along the handle axis (7), a pull rod (19) which is anchored to the tensioning band (10) and is displaceable along the handle axis (7), and a tensioning wheel (18) which can be rotated about the handle axis (7) and engages in an external thread (36) of the pull rod (19). The damper (6) connects the handle rod (2) to the fastening mechanism (3). The damper (6) has at least one longitudinal side (26), which is oriented at an inclination to the fastening axis (12), of a leaf spring (23), wherein the leaf spring (23) has a slot (30) which extends along the handle axis (7). A splint (31) is fastened to the pull rod (19) and engages in the slot (30) in the leaf spring (23).

### FIELD OF THE INVENTION

The present invention relates to a side handle for a hand-operated power tool.

A side handle is known from EP 1674216 B1. The side handle has a handle rod and a fastening mechanism. The handle rod is attached by the fastening mechanism by means of a leaf spring bent into a ring.

### DISCLOSURE OF THE INVENTION

The side handle for a hand-operated power tool has a handle rod arranged along a handle axis for holding the side handle with one hand, a fastening mechanism, and a damper. The fastening mechanism for releasably fastening the side handle to the hand-operated power tool has a tensioning band, which engages around the fastening axis, and a tensioning mechanism. The tensioning mechanism has a collar that overlaps with the tensioning band along the handle axis and is displaceable with respect to the tensioning band along the handle axis, a pull rod that is anchored to the tensioning band and is displaceable along the handle axis, and a tensioning wheel that can be rotated about the handle axis and engages in an external thread of the pull rod. The damper connects the handle rod to the fastening mechanism. The damper has at least one longitudinal side, which is oriented at an inclination to the fastening axis, of a leaf spring, wherein the leaf spring has a slot, which extends along the handle axis. A splint is fastened to the pull rod and engages in the slot in the leaf spring. The splint of the pull rod ensures the orientation of the leaf spring in relation to the fastening axis, without influencing the damping behavior or impairing the simple, tool-free fastening to the tensioning wheel.

One design provides that the leaf spring is oriented perpendicular to the fastening axis; the splint can be oriented longitudinally or parallel to the fastening axis.

One design provides that the damper has a safety retainer, which is fastened to the handle rod and in which the leaf spring is arranged, wherein the cage has a slot, into which the splint engages, running along the handle axis. The safety retainer protects the user should the leaf spring break, by the handle rod still being connected via the splint and the pull rod to the fastening mechanism.

In one design, the safety retainer may have an inclined interior surface, which distance to the longitudinal side of the leaf spring increases in the direction from the handle rod to the fastening mechanism. In addition or as an alternative, the tensioning wheel may have a border protruding in the direction toward the handle rod, said border overlapping along the handle axis with the safety retainer. The border has a clearance to safety retainer in a radial direction to the handle axis. The designs limit a deflection of the leaf spring to prevent an overload, without influencing the damping behavior of the leaf spring in the event of a slight deflection.

One design provides that the leaf spring has two longitudinal sides parallel to each other, which are connected to each other via transverse sides running perpendicular to the handle axis. Through the form, the leaf spring has an inherently high mechanical stability, particularly in relation to torsion loads.

One design provides that one of the transverse sides of the leaf spring has a hole on the handle axis, and the tensioning wheel abutting the transverse side has a nut, which has a neck guided through the hole and a head back-gripping the hole. The structure allows a fastening of the leaf spring with a small number of components.

### BRIEF DESCRIPTION OF THE DRAWINGS

The following description explains the invention using illustrative embodiments and drawings.

Shown in the drawings are:

FIG. 1 a side handle in a longitudinal cross-section; and

FIG. 2 the side handle in a longitudinal cross-section perpendicular to FIG. 2;

The same or function-identical elements are indicated using the same reference signs in the drawings, unless specified otherwise.

### EMBODIMENTS OF THE INVENTION

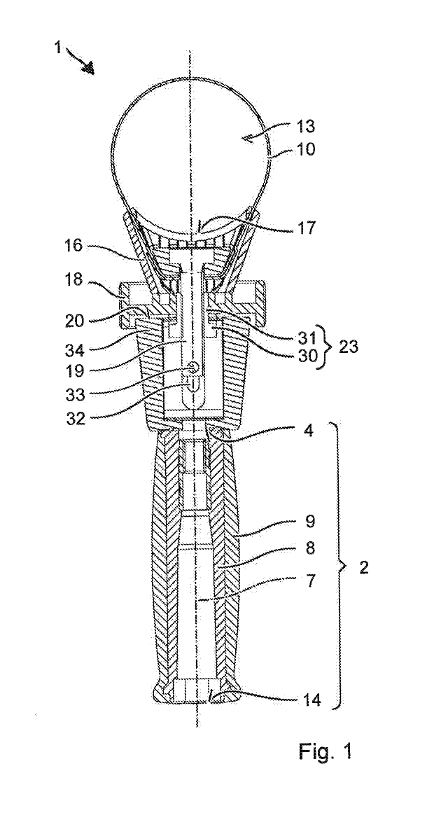

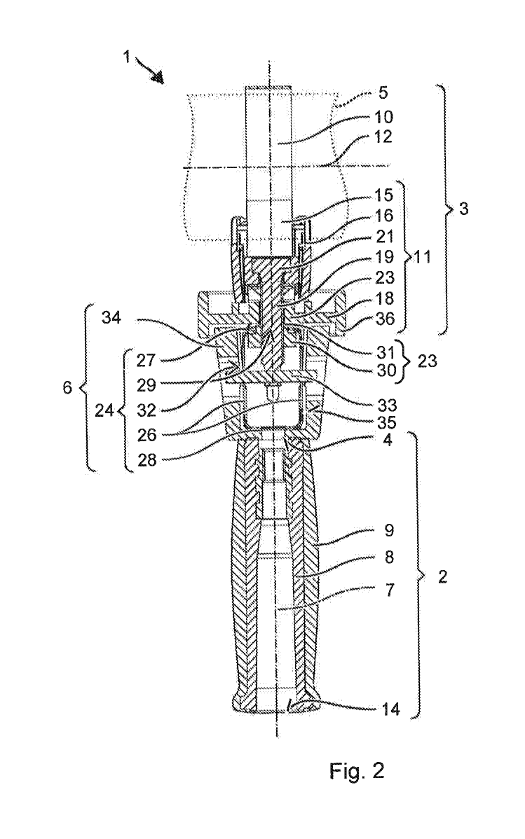

FIGS. 1 and 2 depict an illustrative side handle 1 in two longitudinal cross-sections. Side handle 1 has a handle rod 2 and a fastening mechanism 3, which on one side is arranged at a proximal end 4 of handle rod 2. Fastening mechanism 3 allows one to fasten side handle 1 to a hand-operated power tool 5 and to release said side handle from said power tool. The user can grip handle rod 2 to hold and guide a hand-operated power tool when operating it. Between handle rod 2 and fastening mechanism 3, there is arranged a damper 6, which decreases a transfer of vibrations of hand-operated power tool 5 to handle rod 2.

Handle rod 2 is an elongated rod, which can be gripped around with one hand by the user. The longitudinal axis of the rod is hereinafter designated handle axis 7. Handle rod 2 may have a handle section, which diameter and length are preferably configured according to ergonomic factors. Illustrative handle rod 2 is rotation-symmetric to handle axis 7. As depicted, handle rod 2 may be designed bulbously or cylindrically or non-symmetrically with a contour for the fingers. Handle rod 2 may have a hollow, cylindrical base body 8 made of a hard plastic. Base body 8 is preferably encapsulated with an outer cover 9 made of a soft foam material or elastomer.

Fastening mechanism 3 has a tensioning band 10 and a tensioning mechanism 11. Tensioning band 10 is preferably a metal band bent into a loop, [or] alternatively a textile strip. Tensioning band 10 orients side handle 1 on hand-operated power tool 5 along a fastening axis 12. Fastening axis 12 is defined by eye 13 of tensioning band 10. Fastening axis 12 runs perpendicular through the center of eye 13. The user can push tensioning band 10 on to the housing of the hand-operated power tool 5 along the fastening axis 12; typically, side handle 1 is oriented with its fastening axis 12 parallel to a working axis of the hand-operated power tool 5, e.g., by the tensioning band 10 being seated around a cylindrical section near a tool holder. Fastening axis 12 lies in one plane with handle axis 7; fastening axis 12 is preferably perpendicular or inclined at least by more than 60 degrees relative to handle axis 7.

Fastening mechanism 3 lies offset to handle rod 2 on handle axis 7. Proximal end 4, lying on handle axis 7, of handle rod 2 has a distal end 14 pointing to fastening mechanism 3; a distal end 14 faces away from fastening mechanism 3. The terms “proximal” and “distal” are based on the provided arrangement of side handle 1 on hand-operated power tool 5. Proximal end 4 is the end along handle axis 7 of hand-operated power tool 5 and closer to fastening axis 12 respectively, and correspondingly distal end 14 is the end further away. Handle rod 2 and handle axis 7 typically stick out perpendicular from the housing of hand-operated power tool 5.

Illustrative tensioning mechanism 11 separates a section 15 of tensioning band away from the housing, whereby the remaining section is clamped to the housing. Tensioning mechanism 11 has a collar 16, which partially overlaps with eye 13 of tensioning band 10. Tensioning band 10 may be displaced relative to collar 16 along handle axis 7, as the overlap of collar 16 with eye 13 increases. The free opening of eye 13 decreases, by means of which tensioning band 10 is clamped to the housing. Collar 16 has a support surface 17 facing away from handle rod 2, said surface being designed in a circular arc-shape for example. Support surface 17 may be designed in a complementary manner to the contour of the housing of hand-operated power tool 5; however, it may also be designed simply by one or more support struts, which abut the housing only in a point-wise manner. Illustrative collar 16 is saucer-shaped with two parallel circular arc-shaped support braces 17, between which there is a gap in the width of tensioning band 10. Section 15 of tensioning band 10 runs partially between support surfaces 17 in the gap.

Tensioning mechanism 11 has a tensioning wheel 18 and a pull rod 19, which displace a section 15, near collar 16, of tensioning band 10 relative to collar 16. Tensioning wheel 18 is rotatably seated on collar 16 around handle axis 7. Tensioning wheel 18 is braced along handle axis 7 at least in the direction toward tensioning band 10, i.e., support surface 17 of collar 16, for example on a side 20, facing handle rod 2, of collar 16. Pull rod 19 is arranged coaxially to handle axis 7 and is movable along it. Pull rod 19 is anchored in section 15 near collar 16. Preferably, pull rod 19 cannot rotate relative to tensioning band 10 about handle axis 7. For example, pull rod 19 is welded on to tensioning band 10. Alternatively, a head 21 of pull rod 19 is caught in a form-fitting manner in collar 16 and is moveable only along handle axis 7. Tensioning band 10 is also not rotatable about handle axis 7 relative to collar 16.

Pull rod 19 has a worm thread or a similar tooth arrangement, in which a nut 22 of tensioning wheel 18 engages. The user can turn the tensioning wheel 18 by hand and also displace pull rod 19 along handle axis 7. In doing so, section 15 is moved through pull rod 19 in relation to collar 16—if necessary its overlap with collar 16 is increased—to clamp the other section of tensioning band 10 to the housing of hand-operated power tool 5.

Handle rod 2 and fastening mechanism 3 are connected to each other by means of damper 6 positioned between them. Damper 6 allows for a relative deflection of handle rod 2 in relation to fastening mechanism 3 along fastening axis 12; however, damper 6 thereby exerts a force counteracting the deflection. Oriented longitudinally to handle axis 7, damper 6 comprises a leaf spring 23, which distal section 24 is fastened to handle rod 2 and its proximal section 25 is fastened to fastening mechanism 3.

Illustrative damper 6 comprises a leaf spring 23 bent into a ring. Leaf spring 23 has two longitudinal sides 26, which are essentially parallel to handle axis 7 and perpendicular to fastening axis 12. The two longitudinal sides 26 are connected by transverse sides 25, 24 running essentially perpendicular to handle axis 7. One of the transverse sides 24 forms the distal section of leaf spring 23 and can for example be cast into handle rod 2 or be screw-connected to handle rod 2. The other one of the transverse sides 25 forms the proximal section of leaf spring 23 and is fastened to fastening mechanism 3. Proximal transverse section 25 is held along handle axis 7 from one side by tensioning wheel 18 and from the other side by a nut 22. Proximal transverse side 25 has a hole 27 laying on handle axis 7. Pull rod 19 runs through hole 27 and engages with its external thread into the internal thread of nut 22. Pull rod 19 connects nut 22, proximal transverse side 24 and thereby leaf spring 23, tensioning wheel 18, collar 16 and tensioning band 10 into a contiguous unit.

Nut 22 has a head 28 and a neck 29. The head has a diameter larger than hole 27; neck 29 has the same diameter as hole 27. Head 28 abuts proximal transverse side 25; neck 29 protrudes through hole 27. Tensioning wheel 18 is non-rotatably connected to neck 29. For example, neck 29 has a level key surface or a design otherwise asymmetric to handle axis 7. The turning of tensioning wheel 18 is transferred to nut 22 and moves pull rod 19 along handle axis 7.

Longitudinal sides 26 of leaf spring 23 are perpendicular to fastening axis 12. Preferably, longitudinal sides 26 are planar and parallel to each other. Longitudinal sides 26 are each equipped with a slot 30 running along handle axis 7. A splint 7 engages in both slots 30. Splint 31 also sticks into pull rod 19. Splint 31 prevents a twisting of damper 6 in relation to pull rod 19 about handle axis 7. It is hereby ensured that longitudinal sides 26 are oriented perpendicular to fastening axis 12, along which damping is to occur.

Instead of leaf spring 23 with two longitudinal sides 26 bent into a ring, other geometries of leaf springs can be used, as long as these have at least one longitudinal side 26 perpendicular or inclined to fastening axis 12. For example, the leaf spring may be C-shaped, i.e., with a longitudinal side 26 and a distal transverse side 24 and a proximal transverse side 25. Furthermore, the spring leaf may be folded several times to obtain more than two parallel longitudinal sides.

Damper 6 can have a safety retainer 32. Safety retainer 32 is fastened to handle rod 2. Illustrative safety retainer 32 is a hollow cylinder or a hollow, truncated cone. Safety retainer 32 may be open on one side 20 facing fastening mechanism 3. Leaf spring 23 is arranged within safety retainer 32. In a no-load condition, leaf spring 23 is at a distance from interior surfaces 33 of safety retainer 32. A distance of interior surfaces 33 to leaf spring 23 may increase along handle axis 7 of handle rod 2 to fastening mechanism 3. If a deflection of handle rod 2 in relation to fastening mechanism 3 exceeds a critical deflection, leaf spring 23 will abut interior surface 33. Leaf spring 23 is thereby protected against overloading along fastening axis 12.

Tensioning wheel 18 may have a border 34 protruding along handle axis 7, said border overlapping with safety retainer 32 along handle axis 7. Preferably, border 34 engages around safety retainer 34. Border 34 is at a radial distance, in relation to handle axis 7, from safety retainer 32 so as not to influence the damping behavior of damper 6. The radial distance of safety retainer 32 to border 34 is selected in such a manner that in the event of an excessive deflection of handle rod 2 in relation to fastening mechanism 3, safety retainer 32 strikes border 34. Leaf spring 23 is thereby protected from overloading along fastening axis 12.

Safety retainer 32 has two grooves 35 or slots along handle axis 7. Grooves 35 lie opposite slots 30 of leaf spring 23. Splint 31 engages in grooves 35. If leaf spring 23 were to break, safety retainer 32 protects handle rod 2 at pull rod 19 and fastening mechanism 3 respectively, and protects the user from a sudden and complete failure of side handle 1.

1. Side handle for a hand-operated power tool (5) with a handle rod (2) arranged along a handle axis (7) for holding the side handle (1) with one hand, a fastening mechanism (3bz) for releasably fastening the side handle (1bz) to the hand-operated power tool (5bz), which has a tensioning band (10bz) engaging around a fastening axis (12bz), and a tensioning mechanism (11bz), wherein the tensioning mechanism (11bz) has a collar (16) overlapping the tensioning band (10) along the handle axis (7) and displaceable in relation to the tensioning band (10) along the handle axis (7), a pull rod anchored to the tensioning band (10) and displaceable along the handle axis (7), and a tensioning wheel (18) rotatable about the handle axis (7) and engaging in an external thread (36) of the pull rod (19), a damper (6), which connects the handle rod (2) to the fastening mechanism (3) and which has at least one longitudinal side, oriented in an inclined manner to the fastening axis (12), of leaf spring (23), wherein the leaf spring (23) has a slot (30) running along handle axis (7), and a splint (31), which is fastened to the pull rod (19) and engages in the slot (30) of the leaf spring (23).

2. Side handle according to claim 1, characterized in that the leaf spring (23) is oriented perpendicular to the fastening axis (23).

3. Side handle according to claim 1 or 2, characterized in that the splint (31) is oriented along the fastening axis (12). 4, Side handle according to one of the preceding claims, characterized in that the damper (6) has a safety retainer (32), which is fastened to the handle rod (2) and in which the leaf spring (23) is arranged, wherein the retainer (37) has a slit, which runs along the handle axis (7) and in which the splint (31) engages.

5. Side handle (1) according to claim 4, characterized in that the safety retainer (32) has an inclined interior surface (33), which distance to the longitudinal side (26) of the leaf spring (23) increases in the direction from the handle rod (2) to the fastening mechanism (3).

6. Side handle (1) according to claim 4 or 5, characterized in that the tensioning wheel (18) has a border (34) protruding in a direction toward the handle rod (2), said border overlapping the safety retainer (32) along the handle axis (7), and the border (34) has a clearance to the safety retainer (32) in a direction radial to the handle axis (7).

7. Side handle according to one of the preceding claims, characterized in that the leaf spring (23) has two longitudinal sides (26) parallel to each other, which are connected to each other by means of transverse sides (25, 24) running perpendicular to the handle axis (7).

8. Side handle (1) according to claim 7, characterized in that one of the transverse sides (25) has a hole (27) on the handle axis (7) and the tensioning wheel (18) abutting the transverse side (25) has a nut (22), which has a neck (29) guided through the hole (27) and a head (28) back-gripping the hole (27).

9. Side handle (10) according to claim 8, characterized in that the external thread (36) of the pull rod (19) engages in the nut (22).
